(19) United States
(12) Patent Application Publication
(10) Pub. No.: US 2005/0104250 A1
(43) Pub. Date: May 19, 2005

(54) Sports boot and a process for the decoration and reinforcement of the shell of a sports boot

(75) Inventors: Jerome Chaigne, Gruffy (FR); Patrick Bollard, Veyrier Du Lac (FR)

Correspondence Address: GREENBLUM & BERNSTEIN, P.L.C., 1950 ROLAND CLARKE PLACE, RESTON, VA, 20191, US

(73) Assignee: SALOMON S.A., Metz-Tessy (FR)

(21) Appl. No.: 10/975,439

(22) Filed: Oct. 29, 2004

(30) Foreign Application Priority Data
Oct. 31, 2003 (FR) 03.12764

(51) Int. Cl. B28B 7/22

(52) U.S. Cl. 264/255

(57) ABSTRACT

A sports boot and a process for manufacturing a sports boot. The process includes manufacturing one or more components of the sports boot includes the following: preparing an insert that is made as an assembly of three layers, the three layers including a first layer in the form of a film of a first thermoplastic material, a second layer in the form of a decoration, and a third layer in the form an adhesive film. The process further includes opening a mold, the mold including a matrix and a core, and placing the insert into the mold adjacent one of the walls of the mold so that the thermoplastic film of the insert is positioned between the adhesive film and the aforementioned wall of the mold; closing the mold; injecting a second thermoplastic material to cover at least partially the insert; opening again the mold and extracting the component of the sports boot thus manufactured, the insert being positioned against the wall of the matrix of the mold. The sports boot of the invention includes a rigid shell having been manufactured at least partially by molding, using a second thermoplastic material, the shell including an insert placed in contact with the second thermoplastic material, which includes a first layer in the form of a film of a first thermoplastic material, a second layer in the form of an assembly of fibers, and a third layer in the form of an adhesive film.

### CROSS-REFERENCE TO RELATED APPLICATION

This application is based upon French Patent Application No. 03.12764, filed Oct. 31, 2003, the disclosure of which is hereby incorporated by reference thereto in its entirety and the priority of which is hereby claimed under 35 U.S.C. §119.

### BACKGROUND OF THE INVENTION

1. Field of the Invention

The present invention relates to the footwear and a process for the manufacture of footwear, such manufacture being carried out by injection-molding of a thermoplastic material.

More particularly, the invention is directed to boots for snowboarding, skating, and skiing, and the process for manufacturing such boots.

More particularly still, the invention is directed to the decoration and reinforcement of components of such boots and the process for manufacturing such components, carried out by injection-molding.

2. Description of Background and Relevant Information

It is known to decorate parts of a boot by the application of ink on the part after the manufacture of the boot is finished or semi-finished. It is also known to apply desired decoration on the outer surfaces of boot parts with an adhesive.

These known processes result in a surface decoration that is particularly vulnerable to external mechanical and chemical attacks, which include various types of impacts, abrasions, and other contacts. In the case of a ski boot, such attacks directed to the surface of the shell by the ski edges, in particular, but from other sources as well, are frequent and can result in rapid and irremediable degradation of the boot's decoration, such as its graphics, logo, or other design or text, for example. In a general way, and independent of any particular decoration, the injectable plastic materials used for manufacturing ski boots are easily damaged by any contact that occurs particularly between the boot shell and the ski edges.

Another problem of ski boots in current use is caused by the tendency of certain places of the boot shell to creep over time. Creep occurs when the materials from which the shell is made are subjected to sources which tend to stretch such materials. Creep can lead to an at least partial lengthening of the shell and a modification of the mechanical properties of the shell. This is particularly the case for boot shells made of PU (polyurethane) and in places of the shell where the thickness of the material is reduced for the purpose of facilitating flexibility. For example, the overlapping flaps of the collar of a boot are typically made flexible for the purpose of enveloping the lower leg, and are subjected to the traction forces of the tightening mechanisms that are associated with the flaps.

Another disadvantage of materials used in the injection molding of ski boots is that the materials are sensitive to temperature. Thus, under conditions of very low temperatures, a boot tends to be very rigid and it can become difficult if not almost impossible to put on and to remove. Under high temperatures, the boot tends to be more flexible and its mechanical properties are different.

### SUMMARY OF THE INVENTION

An object of the invention is to mitigate the above-mentioned disadvantages and, in particular, to provide a new process for decorating the various components of a sports boot carried out by injection which ensures a decoration that is resistant to mechanical and chemical attacks.

Another object of the invention is to provide a boot whose components, manufactured by injection molding, are reinforced by the use of an insert for both decoration and reinforcement. That object, in particular, is to prevent creep of the injected material, such as thermoplastic material in particular.

The objects of the invention are achieved by the manufacture of a component of a sports boot according to the process which includes the following:
preparing an insert in the form of an assembly of three layers, a first layer comprised of a film of a first thermoplastic material, a second layer in the form of a layer of decoration, and a third layer in the form of an adhesive film;
opening a mold, the mold comprising a matrix and a core;
placing in the mold, near one of the walls of the mold, an insert in such a way that the thermoplastic film is placed between the adhesive film and the aforementioned one of the walls of the mold;
closing the mold;
injecting a second thermoplastic material in the aforementioned mold so that such thermoplastic material covers at least partially the aforementioned insert;
opening the aforementioned mold again and extracting the component of the sports boot thus manufactured.

Advantageously, the first thermoplastic material has a temperature of plasticization higher than the second thermoplastic material, and the injection temperature is selected in such a way that the first layer of the insert does not change phase (such as itself becoming plasticized) during the injection of the second thermoplastic material.

In a first embodiment of the invention, the aforementioned second layer is positioned between the aforementioned first and third layers. The layer of decoration is placed between the thermoplastic film and the adhesive film.

In another embodiment of the invention, it is the third layer that is positioned between the aforementioned first and second layers. It is then the adhesive film that is positioned between the layer of decoration and the thermoplastic film.

Preferably, the layer of decoration is a layer made of an assembly of fibers. The fibers can be textile fibers or non-textile fibers, which are assembled by having been woven, non-woven, knitted, or being superposed, or by having been assembled by other means known to those skilled in the art.

An object of the invention is also achieved by providing a sports boot comprising a rigid shell made at least partially by molding a second thermoplastic material, the aforementioned shell including an insert which includes a first layer comprised of a film of a first thermoplastic material, a second layer comprised of a decoration layer, and a third layer comprised of an adhesive film. The insert is placed in contact with the second thermoplastic material outside the shell or inside the shell, and the adhesive film is placed between the film of the first thermoplastic material and the second thermoplastic material.

### BRIEF DESCRIPTION OF DRAWINGS

Other advantages of the invention will appear with the reading of the description which accompanies the annexed drawing and in which:

FIG. 1 is a side view of a ski boot comprising a part decorated and reinforced according to the invention;

FIG. 2 is a perspective view of the collar of the ski boot of FIG. 1;

FIG. 3 is a view showing the insert assembly used in the method according to a first embodiment of the invention;

FIG. 4 is a partial view, in perspective, of a mold used for the manufacture of the collar of FIG. 1;

FIG. 5 is a side view of a shell base and a collar decorated according to the invention.

### DETAILED DESCRIPTION OF THE INVENTION

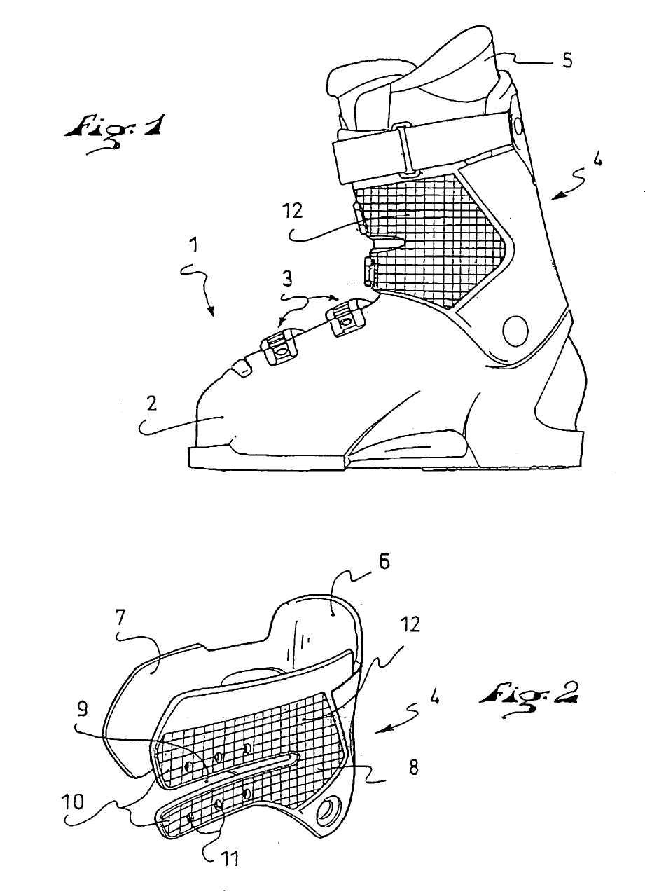

FIG. 1 shows an alpine ski boot 1 decorated and reinforced according to the invention. The figure is a side view showing the internal, or medial, surface of the boot. The boot includes a shell base 2 equipped with two buckles or tightening devices 3, the tightening devices being depicted on the top of the shell base. Each of the tightening devices 3 includes a toothed rack positioned on the internal, or medial, side of the shell base and a hook, or loop, positioned on the external, or lateral, side of the shell base.

A collar 4 is connected to the shell base 2 and, with the shell base, constitutes the shell of an alpine ski boot. Inside the boot a removable comfort liner 5 is preferably fitted. The collar 4 includes a lower part, which receives the element(s) which connect the collar to the shell base, and an upper part which extends around the lower leg of the user. The upper part of the collar includes a relatively rigid rear portion 6, an external flap 7, and an internal flap 8.

The external flap 7 receives the lever mechanisms of the tightening devices 3, while the internal flap 8 receives the toothed racks which cooperate with the lever mechanisms. The use of a system of tightening devices that include hooks/loops and toothed racks is not to be understood as limiting, i.e., other types of tightening devices are within the scope of the invention. Flaps and, in particular, the ends of the flaps, are needed to overlap and, to facilitate their flexion, the flaps have a thickness that is less than that of the remainder of the collar 4. The shell base 2 and the collar 4 are made by injection molding, using a thermoplastic material or materials. In the instant case, a polyurethane (PU) is used, although the use of other materials is also within the scope of the invention.

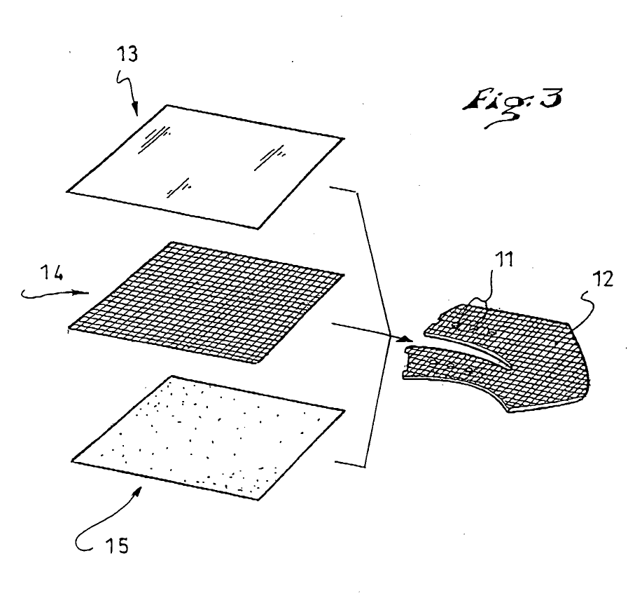

FIG. 2 shows the collar 4, in perspective, separated from the remainder of the boot 1. The internal flap 8 of the collar includes two strips or portions 10, separated by a horizontally extending notch or slot 9. On each one of the strips 10 a toothed rack is to be fixed. Three holes 11 through each of the strips permit the connection of the toothed rack in three distinct places to increase the amplitude of the possible adjustment. The separation of the ends of the internal flap 8 into two strips 10 makes the flap 8 more supple, or flexible. In addition, the tightening devices of the collar acquire a greater autonomy, or independence. The decorative insert 12 is positioned on the internal flap 8 and it is positioned, in particular, on the two strips 10 of the flap. The decorative insert 12 increases resistance to the stretching of the strips 10 and prevents the creep of the PU material even when the strips 10 are subjected to the forces generated by the tightening devices.

In alternate versions, not shown in the drawing, the decorative insert can include a layer in the form of a film on which a decoration is printed, or a layer in the form of a thin metal sheet.

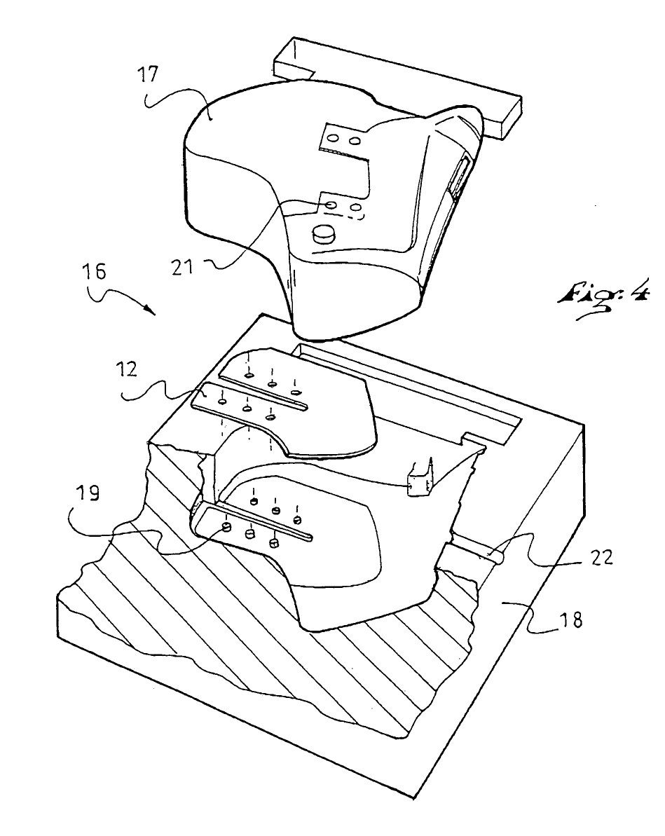

FIG. 3 shows the composition of the decorative insert 12 placed on the collar of the ski boot shown in FIGS. 1 and 2. The insert includes a first layer 13 made of a transparent thermoplastic film, a second layer 14 made of an assembly of fibers forming a textile fabric, or cloth, and a third layer 15 made of an adhesive film. The textile fabric is placed between the transparent film and the adhesive film. The screen provided by the textile fabric of the insert gives to the internal flap a greater creep strength (i.e., resistance to creep) without adversely affecting the flexibility of the flap. As a consequence, the collar ensures a comfortable envelopment of the lower leg while tightening can be carried out effectively. All of these advantages are able to be reproduced throughout the life of the alpine ski boot because the properties of flexibility and tensile strength of the collar are maintained over time, i.e., such as throughout the life of the boot.

To obtain the best results regarding creep strength, it is preferable to use a woven material layer. In addition to facilitating the cohesion of the layers, each one with the others, it would be advantageous to use a textile material having a large and open mesh structure. The transparent film is made of a thermoplastic material different from that which is used in the injection process for manufacturing the shell base and the collar. In this case, a PU film can be used having a thickness of 0.6 millimeters (mm), or approximately 0.6 mm. A thermoplastic film is preferably used which has a thickness greater than 0.2 mm, or greater than about 0.2 mm. The maximum thickness is a function of the final thickness of the part to be injection molded. The film gives to the insert sufficient rigidity to facilitate the insertion and positioning of the insert within the mold. The invention encompasses the use of materials other than PU, such as polyvinylchloride (PVC).

According to a particular embodiment, it is preferable for the visibility of the textile layer that the film be transparent, or substantially transparent. However, alternatives can be utilized within the scope of the invention. For example, the transparent film can be replaced with a more or less translucent film. The aesthetic effect given by the visibility of the textile layer is then filtered inasmuch as the textile material is not distinctly visible. An opaque film can alternatively be used within the scope of the invention if it is desired to allow only the creep strength function for the insert.

The insert 12 is pre-assembled before it is to be inserted into the mold. The textile fabric of the second layer 14 is placed between the film, transparent or otherwise, of the first layer 13 and the adhesive film of the third layer 15. After the three layers are assembled together, the insert 12 is cut out according to the desired dimensions for the particular boot to be manufactured. Such cutting includes creating the external contour of the insert, as well as the plurality of openings as needed, each of which openings provides a respective position for the attachment of the toothed racks of the tightening devices, as explained above.

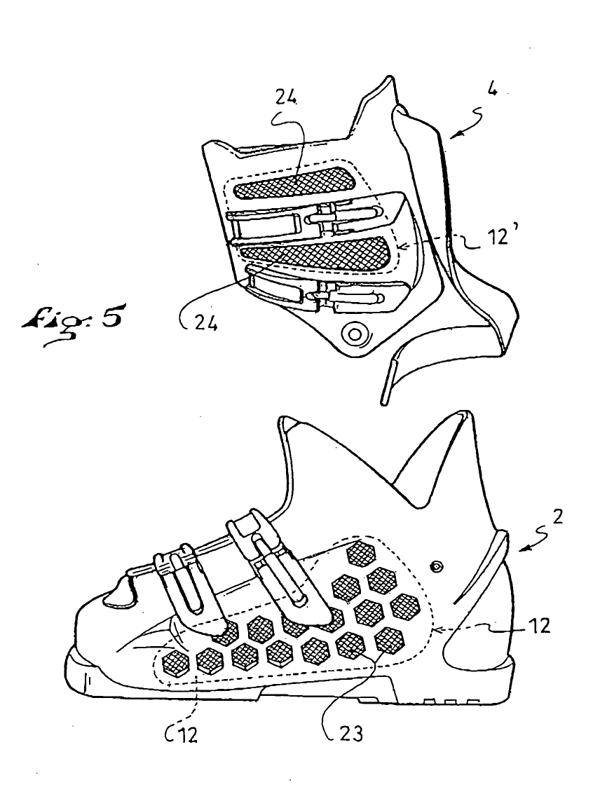

FIG. 4 shows, in perspective, the positioning of the insert 12 in the injection mold 16 for the collar of a ski boot. The mold 16 includes a core 17, or form, and two mold matrices, or mold halves. For reasons of simplicity, only the medial mold half 18, for forming the medial side (or internal side) of the collar, is shown. The bottom of the cavity of the mold half 18 is equipped with a plurality of upwardly projecting studs 19. The studs 19 are positioned to be received in the openings of the insert 12. When the mold 16 is opened, the insert is placed at the bottom of the internal mold matrix 18 and it is positioned by means of the studs 19 being registered within the holes of the insert 12. The form 17 includes recesses complementary with the studs 19 of the mold, such recesses not being visible in FIG. 4, inasmuch as they are on the underside of the mold form 17. However, the recesses for the studs 19 are similar to recesses 21, shown on the top side of the mold form 17, which recesses 21 cooperate with studs that project downwardly from the lateral mold half (for forming the lateral side of the collar), and which recesses are formed for attaching the buckles to the collar in the finished boot. In the closed position of the mold, that is, when the lateral mold half is closed on the medial mold half 18, with the mold form 17 therebetween, projections or raised portion(s) on the underside of the mold form 17 force the insert against the bottom of the mold cavity and the studs 19 penetrate at least partially into the recesses of the mold form 17.

The molten plastic material is then injected through the channel 22. The first thermoplastic material, which constitutes the transparent film of the first layer 13 of the insert 12, has a temperature of plasticization, or melt temperature, higher than that of the second thermoplastic material. The material to be injected and the temperature at which the mold is heated are selected in such a way that the first layer of the insert does not change phase, or melt, during the injection of the second thermoplastic material. Because the adhesive film ensures the cohesion of the various layers that constitute the insert 12, the injected material does not come to be interposed between the fabric layer and the transparent film. Thus, the aesthetic qualities of the insert are not damaged during the injection process.

The presence of the textile fabric of the second layer 14 increases the mechanical strength of the internal flap 8 without increasing the weight thereof. The presence of the textile fabric effectively replaces a quantity of the second thermoplastic material, such as PU, for example, which is injected into the mold, with a material (i.e., the textile fabric) having less weight. In addition, a textile fabric can be chosen such that the fibers thereof are not sensitive, or less sensitive, to the variations in temperature likely to occur during the use of the ski boot.

FIG. 5 illustrates a second embodiment of the invention. The alpine ski boot of FIG. 5 includes a shell-base 2 and a collar 4 shown separated for the convenience of readily understanding the shape and aspects of the two components. As in the first embodiment, the external shell of the ski boot shown in FIG. 5 is made by injection molding of the two principal components, i.e., the shell base 2 and the collar 4. An internal comfort liner, preferably used to supplement the completed boot, is not shown, although a liner such as that which is shown schematically in FIG. 1, or other such liner known to those skilled in the art.

A plurality of cavities 23 are distributed on the external face of the shell base 2 shown in FIG. 5. These cavities are regularly laid out and define a particular pattern. In this case, each cavity has a hexagonal contour and the entire pattern of cavities defines a honeycomb-like structure. The provision and/or the position of the cavities is not limiting and variations are encompassed within the scope of the invention. Because of the structure provided by the cavities 23, the weight of the boot is reduced and the lateral side of the boot is softened, i.e., it is made more flexible. A boot of the type shown is disclosed in WO 03/090572 and in the family member U.S. patent application Ser. No. ______ (Attorney Docket No. P26076), filed on Oct. 25, 2004, the disclosure of the U.S. patent application being hereby incorporated by reference thereto in its entirety.

During the manufacture of the shell base 2, an insert is prepared which includes a first layer, a second layer of textile fabric, and a third layer in the form of an adhesive film. The decoration insert 12, whose contour is represented by a broken line in FIG. 5, has a surface sized and shaped so that it can cover the entire extent of the cavities 23. In this embodiment, the adhesive film of the third layer is placed between the thermoplastic film of the first layer and the textile fabric of the second layer. Before the injection of material, the insert 12 is placed against the core of the mold. The thermoplastic material of the third layer is placed between the adhesive film and the wall of the core against which the insert is pressed. The part thus made is not only decorated by the presence of the textile fabric visible through the cavities 23, but also the part is sealed against the ingress of foreign material, such as snow, water, and/or other debris, because of the presence of the first layer of the insert being made of an impervious plastic. The insert 12, in this case, is placed at the interior/inside of the shell base relative to the plurality of cavities 23, leaving visible, thusly, the pattern of the cavities 23.

By means of an alternative embodiment of the invention, the insert is placed not on the core but against the matrix of the mold. On the finished product, this would result in masking, at least partially, the honeycomb structure of the plurality of cavities 23, as the insert would then cover the outside of the cavities on the finished boot.

Collar 4 presents two openings 24, one of which is positioned between the two buckles (tightening devices) and the other of which is positioned above the uppermost buckle. The openings 24 are made during the injection molding of the collar. An insert 12′ is placed in the mold before injection of the material and blocks each one of the openings 24. The periphery of the insert 12′ is shown in FIG. 5 by means of a broken line.

For the manufacture of the shell base 2, like that of the collar 4, the insert which is placed against the core, is automatically maintained in place by the external matrix as the mold is closed. Indeed, because of the presence of the cavities 23 and the openings 24, the external matrices of the molds for both the shell base and the collar come into contact with the insert during the closing of the mold.

The invention is not limited to the particular details of the aforementioned embodiments shown and described, which are presented merely as exemplary of the invention, the scope of the invention encompasses any sports footwear and the process of manufacturing same, in particular footwear for gliding sports, which include rigid parts made by means of molding using thermoplastic material.

### Nomenclature

1—boot
2—shell base
3—tightening device
4—collar
5—comfort liner
6—rear portion of collar
7—external flap
8—internal flap
9—notch
10—flap strip
11—holes
12, 12′—insert
13—first layer of the insert
14—second layer of the insert
15—third layer of the insert
16—mold
17—core of the mold
18—internal mold matrix
19—studs
21—recesses
22—channel
23—cavities
24—openings

1. A process of manufacturing a component of a sports boot, said process comprising:
preparing an insert as an assembly of three layers, the three layers including a first layer comprising a film of a first thermoplastic material, a second layer comprising a decoration, and a third layer comprising an adhesive film;
opening a mold, the mold comprising a matrix and a core;
placing the insert into the mold, and adjacent a wall of the mold, with the first thermoplastic film being positioned between the adhesive film and the wall of the mold;
closing the mold;
injecting a second thermoplastic material in the mold so that the second thermoplastic material covers at least partially the insert;
opening the mold and to removing the component from the mold.

2. A process according to claim 1, wherein:
the insert is positioned against a wall of the matrix of the mold.

3. A process according to claim 1, wherein:
the insert is positioned against a wall of the core of the mold.

4. A process according to claim 1, wherein:
the layer of decoration comprises a textile fabric.

5. A process according to claim 1, wherein:
the first layer comprises a transparent material.

6. A process according to claim 1, wherein:
the first layer comprises a translucent material.

7. A process according to claim 1, wherein:
the first layer has a thickness greater than 0.2 mm.

8. A process according to claim 1, wherein:
the first layer has a thickness greater than about 0.2 mm.

9. A process according to claim 1, wherein:
the second thermoplastic material covers entirely the insert.

10. A process according to claim 1, wherein:
on a portion of the insert, the matrix and the core of the mold are in contact with the insert.

11. A component of a sports boot made by the process according to claim 1.

12. A sports boot comprising a component made by the process of claim 1.

13. A sports boot comprising:
a rigid shell having been made at least partially by molding a first thermoplastic material, said shell comprising an insert contacting said first thermoplastic material, said insert comprising a first layer comprising a film of a second thermoplastic material, a second layer comprising a decoration, and a third layer comprising an adhesive film.

14. A sports boot according to claim 13, wherein:
the second layer of decoration comprises a textile fabric assembly.

15. A sports boot according to claim 13, wherein:
the shell includes a lateral side and a medial side, the shell comprising a shell base and a collar mounted above the shell base;
the shell insert is positioned on an outer face of the medial side of the collar.

16. A sports boot according to claim 13, wherein:
the shell includes a plurality of cavities spread over at least a portion of an outer face of the shell;
the insert is positioned inside the shell over the plurality the cavities for sealing the shell against foreign material entering the inside of the shell through the cavities.
